(19) United States
(12) Patent Application Publication
(10) Pub. No.: US 2023/0145760 A1
(43) Pub. Date: May 11, 2023

(54) METHOD AND DEVICE FOR CALCULATING MODULAR PRODUCT

(71) Applicant: CRYPTO LAB INC., Seoul (KR)

(72) Inventor: Jung Hee CHEON, SEOUL (KR)

(21) Appl. No.: 17/905,693

(22) PCT Filed: Mar. 12, 2021
(86) PCT No.: PCT/KR2021/003088

§ 371 Date: Sep. 6, 2022

Related U.S. Application Data
(60) Provisional application No. 62/988,598, filed on Mar. 12, 2020.

(30) Foreign Application Priority Data
Mar. 11, 2021 (KR) 10-2021-0032033

(51) Int. Cl. G06F 7/72; G06F 7/50; G06F 5/01; H04L 9/00

(52) U.S. Cl. CPC G06F 7/722; G06F 5/01; G06F 7/50; H04L 9/008

(57) ABSTRACT

Disclosed is a calculation apparatus. The calculation apparatus comprises a memory which stores at least one instruction and a processor which executes the at least one instruction, wherein the processor executes the at least one instruction to store a predetermined base prime number, invert the bits of information about the pre-stored base prime number to generate first prime number information different from the base prime number information, and perform modular calculation on a plurality of ciphertexts by using the generated first prime number information.

### TECHNICAL FIELD

The present disclosure relates to a calculation apparatus for performing modular multiplication, and a method thereof, and more particularly, to a calculation apparatus for performing modular multiplication by generating prime number information (or square root information) necessary for each modulus every cycle by using pre-stored base prime number information, and a method thereof.

### BACKGROUND ART

Machine learning is an excellent solution for various fields such as speech recognition, image classification, and precision medicine and is attracting a lot of attention. Traditional machine learning services require a large amount of data sets for both training and inference to obtain meaningful results. Therefore, privacy preservation is a major concern when providing cloud-based data analysis services.

Homomorphic encryption (HE), which is an encryption system that allows calculation between encrypted data, allows calculation in an encrypted state, and is thus an ideal solution for the privacy preservation described above.

The homomorphic encryption includes somewhat homomorphic encryption (SHE) that supports only a limited number of calculations, and fully homomorphic encryption (FHE) that supports an unlimited number of calculations. In the fully homomorphic encryption, bootstrapping, which is a method of initializing an error in an encrypted data, may be used to perform an unlimited number of modular multiplications.

However, since such bootstrapping requires a large homomorphic calculation and requires a large parameter such as a high degree of polynomial (N), there is a problem in that an overall processing speed is lowered. Therefore, there has been a demand for a method capable of reducing a time required for the bootstrapping for the homomorphic encryption and increasing a bootstrapping speed.

### DISCLOSURE

### Technical Problem

The present disclosure has been made in an effort to solve the above-described problems, and the present disclosure provides a calculation apparatus for performing modular multiplication by generating prime number information (or square root information) necessary for each modulus every cycle by using pre-stored base prime number information, and a method thereof.

### Technical Solution

The present disclosure is intended to achieve the above object, and the calculation apparatus includes: a memory configured to store at least one instruction; and a processor configured to execute the at least one instruction, in which the processor is configured to execute the at least one instruction to store predetermined base prime number information, generate first prime number information different from the base prime number information by reversing bits of the pre-stored base prime number information, and perform a modular calculation for the plurality of ciphertexts by using the generated first prime number information.

The base prime number information and the first prime number information may be values obtained by addition and subtraction of three, four, or five exponentiations of 2 with different exponents.

The processor may include: an internal memory configured to store the base prime number information; a GBU including a plurality of BUs including a plurality of calculators that perform different preset homomorphic calculations; and a prime number generator configured to read the base prime number information from the internal memory, generate prime number information necessary for each of the plurality of BUs by reversing the bits of the base prime number information, and provide the generated prime number information to each of the plurality of BUs.

The prime number generator may generate the prime number information by converting a bit value of a k-th bit of the base prime number information into a log h-th bit integer.

The prime number generator may generate the first prime number information necessary for a first cycle by using the base prime number information, and generate second prime number information necessary for a second cycle by using the generated first prime number information and the base prime number information.

The processor may include a plurality of GBUs, the plurality of GBUs may be arranged in series, and the processor may further include a reordering buffer (RB) configured to store an output value of one of the GBUs and provide the stored output value to another GBU in an order different from a storing order.

The GBU may include a plurality of stages, and a plurality of BUs may be arranged in parallel in each of the plurality of stages.

At least two of the plurality of BUs in one GBU may perform the homomorphic calculations by using the same prime number information.

Each BU may include: a modulus subtractor configured to receive two homomorphic ciphertexts and output a value of a difference between the two homomorphic ciphertexts; a modulus adder configured to receive two homomorphic ciphertexts and output an addition value of the two homomorphic ciphertexts; and a modulus multiplier configured to perform modular multiplication by using the output value of the modulus subtractor and the prime number information.

The modulus multiplier may perform an individual shift calculation based on an exponent of each of a plurality of exponentiations of 2 constituting the prime number information, and perform modular multiplication by performing addition or subtraction of shift calculation results.

The processor may be a field programmable gate array (FPGA).

A ciphertext calculation method according to an embodiment of the present disclosure includes: receiving a modular calculation command for a plurality of ciphertexts; performing a module calculation for the plurality of ciphertexts by using prime number information expressed by a combination of exponentiations of 2; and outputting a result of the calculation, wherein in the performing of the modular calculation, base prime number information may be stored, bits of the prime number information may be reversed to generate first prime number information different from the base prime number information, and the modular calculation for the plurality of ciphertexts may be performed by using the generated first prime number information.

The base prime number information and the first prime number information may be values obtained by addition and subtraction of three, four, or five exponentiations of 2 with different exponents.

In the performing of the modular calculation, the first prime number information may be generated by converting a bit value of a k-th bit of the base prime number information into a log h-th bit integer.

In the performing of the modular calculation, the first prime number information necessary for a first cycle may be generated by using the base prime number information, and second prime number information necessary for a second cycle may be generated by using the generated first prime number information and the base prime number information.

### Advantageous Effects

According to various embodiments of the present disclosure as described above, in the ciphertext calculation method according to the present disclosure, a modulus calculation is performed using prime number information expressed by a combination of exponentiations of 2. Therefore, the calculation may be performed at a high speed. Further, only the base prime number information is stored, and prime number information (or square root information) necessary for the modulus calculation is generated every cycle, instead of storing all prime number information necessary for the calculation. Therefore, the modulus calculation may be performed at a high speed in hardware with a small internal memory.

### BRIEF DESCRIPTION OF DRAWINGS

FIG. 1 is a diagram for describing a structure of a network system according to an embodiment of the present disclosure.

FIG. 2 is a block diagram illustrating a configuration of a calculation apparatus according to an embodiment of the present disclosure.

FIG. 3 is a flowchart for describing a ciphertext calculation method according to an embodiment of the present disclosure.

FIG. 4 is a diagram for describing an iNTTiNTT algorithm according to a first embodiment of the present disclosure.

FIG. 5 is a diagram illustrating an example of a first prime number set according to an embodiment of the present disclosure.

FIG. 6 is a diagram illustrating an example of a second prime number set according to an embodiment of the present disclosure.

FIG. 7 is a diagram for describing an iNTTiNTT algorithm according to a second embodiment of the present disclosure.

FIG. 8 is a diagram illustrating a configuration of a BU according to the first embodiment of the present disclosure.

FIG. 9 is a diagram for describing an operation timing of the BU of FIG. 8.

FIG. 10 is a diagram for describing an operation timing in a case where the BU is operated with the algorithm of FIG. 7.

FIG. 11 is a diagram for describing an operation timing in a case where a plurality of BUs are arranged in parallel.

FIG. 12 is a diagram illustrating a configuration of a GBU according to an embodiment of the present disclosure.

FIG. 13 is a diagram for describing an operation timing in a case where iNTTiNTT is designed with SET B of Table 1.

FIG. 14 is a diagram illustrating a configuration of an RB according to an embodiment of the present disclosure.

FIG. 15 is a diagram illustrating a configuration of a prime number generator according to an embodiment of the present disclosure.

FIG. 16 is a diagram for describing an example of data stored in an internal memory according to an embodiment of the present disclosure.

FIG. 17 is a diagram for describing a structure of a processor according to an embodiment of the present disclosure.

### BEST MODE FOR CARRYING OUT THE INVENTION

### Mode for Carrying Out the Invention

Hereinafter, the present disclosure will be described in detail with reference to the accompanying drawings. In an information (data) transmission process performed in the present disclosure, encryption/decryption may be applied as needed. In the present disclosure and claims, expressions describing the information (data) transmission process are to be construed as including the case of performing encryption/decryption, even if not mentioned separately. Expressions such as “transmit (transfer) from A to B” or “receive by A from B” in the present disclosure include transmission (transfer) or reception with another medium in between, and do not just represent direct transmission (transfer) from A to B or direct reception by A from B.

In the description of the present disclosure, the order of each step should be understood in a non-limited manner unless a preceding step should be performed logically and temporally before a following step. That is, except for the exceptional cases as described above, even if a process described as a following step is preceded by a process described as a preceding step, it does not affect the nature of the present disclosure, and the scope of rights should be defined regardless of the order of the steps. In addition, in the specification, “A or B” is defined not only as selectively referring to either A or B, but also as including both A and B. In addition, in the present specification, the term “comprise” has a meaning of further including other components in addition to the components listed.

Only essential components necessary for explanation of the present disclosure are described in the present disclosure, and components not related to the essence of the present disclosure are not mentioned. The present disclosure should not be construed in an exclusive sense that includes only the recited elements, but should be interpreted in a non-exclusive sense to include other elements as well.

In the present disclosure, the term “value” is defined as including not only a scalar value but also a vector and a polynomial.

A mathematical calculation and calculation of each step of the present disclosure to be described later may be implemented by a computer operation by a well-known coding method for carrying out the calculation or the calculation, and/or coding designed suitable for the present disclosure.

Specific expressions described below are exemplarily described among various possible alternatives, and the scope of the present disclosure should not be construed as being limited to the expressions mentioned in the present disclosure.

For convenience of explanation, the following notations will be used in the present disclosure.
a ← D: Select element (a) according to distribution (D).
s₁, s₂∈ R: Each of s₁ and s₂ is an element of a set R.
mod(q): Perform a modular calculation by an element q.

$$\left⌊-\right⌋$$
: Round up an internal value.
Hereinafter, various embodiments of the present disclosure will be described in detail with reference to the accompanying drawings.

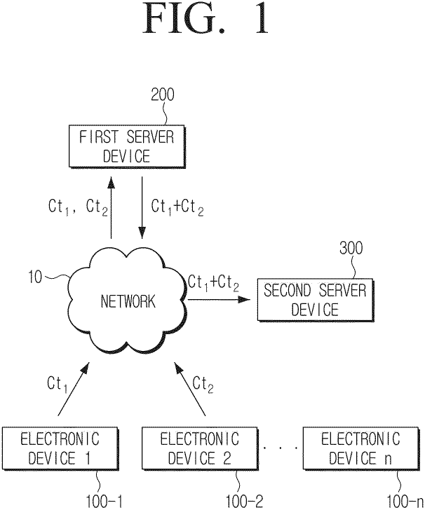

FIG. 1 is a diagram for describing a network system according to an embodiment of the present disclosure.

Referring to FIG. 1, the network system may include a plurality of electronic devices 100-1 to 100-n, a first server device 200, and a second server device 300, and the respective components may be connected to one another through a network 10.

The network 10 may be implemented by various types of wired and wireless communication networks, a broadcasting communication network, an optical communication network, a cloud network, or the like, and the respective devices may be connected to each other by a method such as wireless fidelity (Wi-Fi), Bluetooth, and near field communication (NFC), without a separate medium.

Although FIG. 1 illustrates a case where the number of electronic devices is plural (100-1 to 100-n), it is not necessary that a plurality of electronic devices are used, and only one electronic device may be used. As an example, the electronic devices 100-1 to 100-n may be implemented by various types of devices such as a smartphone, a tablet personal computer (PC), a game machine, a PC, a laptop PC, a home server, and a kiosk, and may also be implemented by a home appliance with an Internet of Things (IoT) function.

A user may input various information through the electronic devices 100-1 to 100-n that the user uses. The input information may be stored in the electronic devices 100-1 to 100-n and may also be transmitted to and stored in an external device for a reason such as capacity and security. In FIG. 1, the first server device 200 may serve to store such information and the second server device 300 may serve to use a part or all of information stored in the first server device 200.

Each of the electronic devices 100-1 to 100-n may perform homomorphic encryption on the input information and transmit a homomorphic ciphertext to the first server device 200.

Each of the electronic devices 100-1 to 100-n may allow an encryption noise calculated in a process of performing the homomorphic encryption, that is, an error, to be included in the ciphertext. For example, the homomorphic ciphertext generated by each of the electronic devices 100-1 to 100-n may be generated in a form in which a result value including a message and an error value is restored when the homomorphic ciphertext is decrypted by using a secret key later.

As an example, the homomorphic ciphertext generated by each of the electronic devices 100-1 to 100-n may be generated in a form in which the following property is satisfied when the homomorphic ciphertext is decrypted by using the secret key.

$$\text{Dec} \left(\text{ct, sk}\right) = < \text{ct, sk} > \text{= M+e} \left(mod \text{q}\right)$$

Here, < , > refers to a usual inner product, ct denotes a ciphertext, sk denotes a secret key, M denotes a plaintext message, e denotes an encryption error value, and mod q denotes a modulus of the ciphertext. It is necessary that a value that is larger than a result value M obtained by multiplying the message and a scaling factor Δ is selected as q. As long as an absolute value of the error value e is sufficiently smaller than M, a decryption value (M + e) of the ciphertext may replace the original message with the same precision in significant digit arithmetic. In decrypted data, the error may be arranged on the least significant bit (LSB) side and M may be arranged on the second least significant bit side.

In a case where a size of the message is excessively small or large, the size of the message may be adjusted by using the scaling factor. In a case of using the scaling factor, a message in a real number form may be encrypted in addition to a message in an integer form, and thus applicability may be greatly improved. Further, a size of an area where messages are present in a ciphertext after the calculation, that is, a size of an effective area may be adjusted by adjusting the size of the message using the scaling factor.

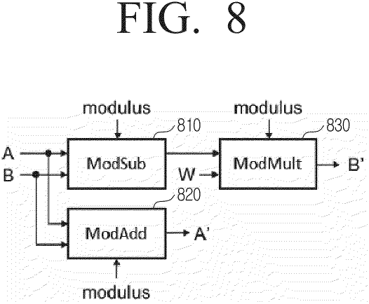

According to an embodiment, the modulus q of the ciphertext may be set in various forms and used. As an example, the modulus of the ciphertext may be set in a form of exponentiation of the scaling factor Δ, that is, q = Δ^{L}. In a case where Δ is 2, the modulus of the ciphertext may be set in a form in which, for example, q = 2¹⁰. Alternatively, q may be expressed by a combination of exponentiations of 2 satisfying a certain condition as illustrated in FIG. 8.

As another example, the modulus of the ciphertext may be set to a value obtained by multiplying a plurality of different scaling factors. The respective factors may be set to values within similar ranges, that is, similar values. For example, the scaling factors may be set so that q = q₁, q₂, q₃, ..., and qₓ, and q₁, q₂, q₃, ..., and qₓ may each have a value similar to the scaling factor Δ and may be set to values that are disjoint from each other.

In a case where the scaling factor is set in the above-described manner, the entire calculation may be divided into a plurality of modulus calculations and performed according to a Chinese remainder theorem (CRT), thereby reducing calculation loads.

Further, as factors having similar values are used, almost the same result as the result value in the above-described example may be obtained when rounding processing is performed in a process as described later.

The first server device 200 may store the received homomorphic ciphertext as it is without performing decryption.

The second server device 300 may request for a specific processing result of the homomorphic ciphertext to the first server device 200. The first server device 200 may perform a specific calculation according to the request from the second server device 300 and then transmit a result of the calculation to the second server device 300.

As an example, in a case where ciphertexts ct₁ and ct₂ transmitted by two electronic devices 100-1 and 100-2 are stored in the first server device 200, the second server device 300 may request for a value obtained by adding up information provided from the two electronic devices 100-1 and 100-2 to the first server device 200. The first server device 200 may perform a calculation of adding up two ciphertexts according to the request and then transmit a result value (ct₁ + ct₂) to the second server device 300.

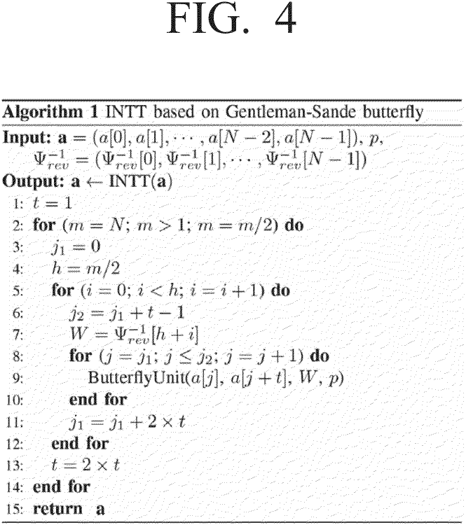

Due to the property of the homomorphic ciphertext, the first server device 200 may perform the calculation without performing decryption and a result value of the calculation may also have a ciphertext form. Here, the first server device 200 may perform fast bootstrapping for the calculation result by applying an algorithm as described later. A fast bootstrapping method according to the present disclosure will be described later with reference to FIG. 4.

The first server device 200 may transmit a calculation result ciphertext to the second server device 300. The second server device 300 may decrypt the received calculation result ciphertext to obtain a calculation result value of data included in each homomorphic ciphertext. Further, the first server device 200 may perform the calculation multiple times according to a request from the user.

Meanwhile, although FIG. 1 illustrates a case where the first and second electronic devices perform the encryption and the second server device performs the decryption, the present disclosure is not limited thereto.

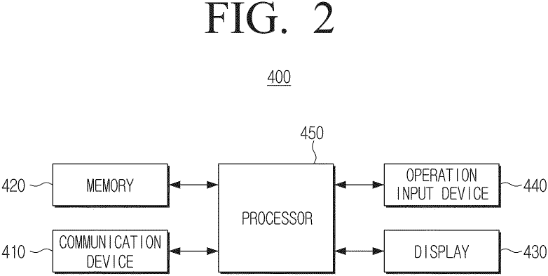

FIG. 2 is a block diagram illustrating a configuration of a calculation apparatus according to an embodiment of the present disclosure.

For example, in the system of FIG. 1, a device that performs the homomorphic encryption, such as the first electronic device or the second electronic device, a device that performs a calculation for a homomorphic ciphertext, such as the first server device, a device that performs decryption of a homomorphic ciphertext, such as the second server device, or the like may be referred to as the calculation apparatus. Such a calculation apparatus may be implemented by various types of devices such as a PC, a notebook PC, a smartphone, a tablet PC, a server, and the like.

Referring to FIG. 2, a calculation apparatus 400 may include a communication device 410, a memory 420, a display 430, an operation input device 440, and a processor 450.

The communication device 410 is formed to connect the calculation apparatus 400 to an external device (not illustrated), and may be connected to the external device through a local area network (LAN) and the Internet network or be connected to the external device through a universal serial bus (USB) port or a wireless communication (for example, Wi-Fi 802.11a/b/g/n, NFC, or Bluetooth) port. Such a communication device 410 may also be referred to as a transceiver.

The communication device 410 may receive a public key from the external device and may transmit a public key generated by the calculation apparatus 400 itself to the external device.

Further, the communication device 410 may receive a message from the external device and may transmit a generated homomorphic ciphertext to the external device.

Further, the communication device 410 may receive various parameters required for ciphertext generation from the external device. Meanwhile, in an actual implementation, the various parameters may be directly input by the user through the operation input device 440 as described later.

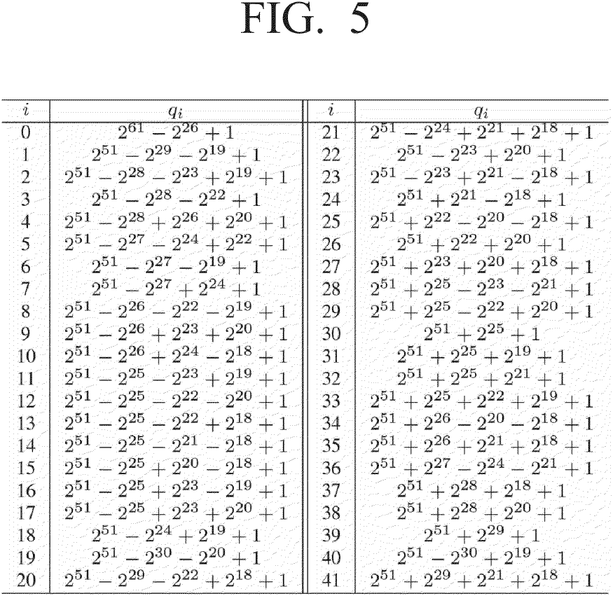

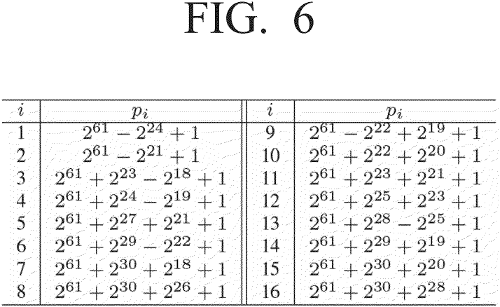

Further, the communication device 410 may receive a request for a calculation for the homomorphic ciphertext from the external device and may transmit a result of the calculation to the external device. Here, the requested calculation may be a calculation such as addition, subtraction, or multiplication (for example, modular multiplication). Here, the modular multiplication means a modular calculation with a q element. Further, a value expressed by a combination of exponentiations of 2 as illustrated in FIGS. 5 or 6 may be used as the q element.

The memory 420 may store at least one instruction related to the calculation apparatus 400. For example, the memory 420 may store various programs (or software) for operation of the calculation apparatus 400 according to various embodiments of the present disclosure.

Such a memory 420 may be implemented in various forms such as a random access memory (RAM), a read only memory (ROM), a buffer, a cache, a flash memory, a hard disk drive (HDD), an external memory, and a memory card, but is not limited thereto.

The memory 420 may store a message to be encrypted. Here, the message may be various information used by the user such as credit information and personal information, or may be information used by the calculation apparatus 400 such as position information or information related to a use history or the like such as Internet use time information.

Further, the memory 420 may store a public key, and in a case where the calculation apparatus 400 directly generates a public key, the memory 420 may store various parameters required for generation of the public key and the secret key.

In addition, the memory 420 may store a plurality of prime number information. Here, each of the plurality of prime number information may be expressed by a combination of exponentiations of 2. Specifically, the prime number information stored in the memory 420 may be base prime number information that may be used to generate other prime number information as described later. Further, the memory 420 may also store reciprocal number information corresponding to the prime number information, together with the prime number information.

Further, the memory 420 may store a homomorphic ciphertext generated in a process as described later. In addition, the memory 420 may also store a homomorphic ciphertext transmitted from the external device. Further, the memory 420 may also store a calculation result ciphertext which is a result of a calculation process as described later.

The display 430 displays a user interface window for the user to select a function supported by the calculation apparatus 400. For example, the display 430 may display a user interface window for the user to select various functions provided by the calculation apparatus 400. Such a display 430 may be a monitor such as a liquid crystal display (LCD) monitor or an organic light emitting diode (OLED) monitor, or may be implemented by a touch screen that may simultaneously function as the operation input device 440 as described later.

The display 430 may display a message for requesting an input of a parameter required for the generation of the secret key and the public key. Further, the display 430 may display a message for selection of a message as an encryption target. Meanwhile, in an actual implementation, the encryption target may be directly selected by the user or may be automatically selected. That is, personal information requiring encryption and the like may be automatically set as the encryption target without direct selection of a message by the user.

The operation input device 440 may receive selection of a function of the calculation apparatus 400 and a control command for the corresponding function from the user. For example, the operation input device 440 may receive a parameter required for the generation of the secret key and the public key from the user. Further, the user may set a message to be encrypted, through the operation input device 440.

The processor 450 controls a general operation of the calculation apparatus 400. For example, the processor 450 may control the general operation of the calculation apparatus 400 by executing at least one instruction stored in the memory 420. Such a processor 450 may be implemented by a single device such as a central processing unit (CPU) or an application-specific integrated circuit (ASIC), or may be implemented by a plurality of devices such as a CPU and a graphics processing unit (GPU).

Once a message to be transmitted is input, the processor 450 may store the message in the memory 420. Then, the processor 450 may perform the homomorphic encryption on the message by using various setting values and programs stored in the memory 420. In this case, the public key may be used.

The processor 450 may generate the public key required for the encryption by itself, or may receive the public key from the external device. As an example, the second server device 300 which performs decryption may distribute the public key to other devices.

In a case where the processor 450 generates the public key by itself, the processor 450 may generate the public key by using Ring learning with errors (Ring-LWE). For example, the processor 450 may first set various parameters and rings, and store the parameters and rings in the memory 420. Examples of the parameter may include a bit length of a plaintext message, a size of the public key, and a size of the secret key. Examples of various parameters used in the present disclosure and values thereof will be described in detail with reference to FIG. 4.

The ring may be expressed by the following Expression 2.

$$R = \frac{{Z}_{q} \left[X\right]}{f \left(x\right)}$$

Here, R denotes the ring, Z_{q} denotes a coefficient, and f(x) denotes an n-th polynomial.

The ring refers to a set of polynomials with a predetermined coefficient, and means a set in which addition and multiplication are defined between elements and which is closed under addition and multiplication. Such a ring may also be referred to as a polynomial ring.

As an example, the ring refers to a set of n-th polynomials with a coefficient of Z_{q}. For example, the ring may mean an N-th cyclotomic polynomial when n is Φ(N). (f(x)) denotes an ideal of Z_{q}[x] generated by f(x). Euler’s totient function Φ(N) denotes the number of natural numbers that are disjoint from N and are smaller than N. When Φ_{N}(x) is defined as an N-th cyclotomic polynomial, the ring may also be expressed by the following Expression 3. Here, N may be 2¹⁷.

$$R = \frac{{Z}_{q} \left[X\right]}{{Φ}_{N} \left(x\right)}$$

The secret key (sk) may be expressed as follows.

Meanwhile, the ring in Expression 3 includes a plaintext space that is a complex number. Meanwhile, among the sets as the ring described above, only a set including a plaintext space that is a real number may be used, to increase a calculation speed for the homomorphic ciphertext.

In a case where such a ring is set, the processor 450 may calculate the secret key (sk) from the ring.

$$\text{sk} ← \left(1 , \text{s} \left(\text{x}\right)\right) , \text{s} \left(\text{x}\right) ∈ \text{R}$$

Here, s(x) denotes a polynomial randomly generated with a small coefficient.

Further, the processor 450 may calculate a first random polynomial (a(x)) from the ring. The first random polynomial may be expressed as follows.

$$\text{a} \left(\text{x}\right) ← \text{R}$$

In addition, the processor 450 may calculate an error. For example, the processor 450 may extract an error from a discrete Gaussian distribution or a distribution within a short statistical distance thereto. Such an error may be expressed as follows.

$$\text{e} \left(\text{x}\right) ← {\text{D}}^{\text{n}} α \text{q}$$

Once the error is calculated, the processor 450 may perform a modular calculation of the error with the first random polynomial and the secret key to calculate a second random polynomial. The second random polynomial may be expressed as follows.

$$\text{b} \left(\text{x}\right) \text{=-a} \left(\text{x}\right) \text{s} \left(\text{x}\right) \text{+} \text{e} \left(\text{x}\right) \left(\text{mod} \text{q}\right)$$

Finally, the public key (pk) may be set as follows in a form in which the first random polynomial and the second random polynomial are included. Meanwhile, in a case where the calculation apparatus 400 supports residue number system (RNS)-homomorphic encryption for approximate number (HEAAN) (or HEaaN™), the processor 450 may generate a plurality of public keys corresponding to a plurality of integers that are disjoint from each other, respectively.

Here, the RNS-HEAAN is a method in which R_{qi} (qᵢ = Δⁱ) which is an existing ciphertext space is substituted with R_{qi} (qᵢ = Πpi, Δⁱ), pi ≈ Δ) to resolve the problem that a method such as the Chinese remainder theorem is not applicable to the existing HEAAN. Accordingly, an approximate calculation result that a size of error bits is larger by about 5 to 10 is obtained, but the calculation speed may be increased by 3 to 10 times. A specific ciphertext calculation using the RNS-HEAAN will be described later with reference to FIG. 4.

$$\text{pk=} \left(\text{b} \left(\text{x}\right) \text{,} \text{a} \left(\text{x}\right)\right)$$

The above-described key generation method is only an example, and the present disclosure is not necessarily limited thereto, and it is a matter of course that the public key and the secret key may be generated by using other methods.

Meanwhile, once the public key is generated, the processor 450 may control the communication device 410 to transmit the public key to other devices.

Further, the processor 450 may generate a homomorphic ciphertext for the message. For example, the processor 450 may generate a homomorphic ciphertext by applying the public key generated as described above to the message. Here, the processor 450 may perform an encryption operation by using the prime number information as illustrated in FIGS. 5 or 6 in the process of generating the homomorphic ciphertext.

A message to be decrypted may be received from an external source or may be input through an input device directly provided in or connected to the calculation apparatus 400. For example, in a case where the calculation apparatus 400 includes a touch screen or a keypad, the processor 450 may store data input by the user through the touch screen or the keypad in the memory 420 and perform encryption on the data. Based on decryption being performed, the generated homomorphic ciphertext may be restored to a result value obtained by adding an error to a value obtained by reflecting the scaling factor in the message. As the scaling factor, a value that is input in advance and set may be used as it is.

Meanwhile, in a case where the calculation apparatus 400 supports the RNS-HEAAN, the processor 450 may generate a homomorphic ciphertext expressed as a plurality of bases, by using a plurality of public keys corresponding to a plurality of integers that are disjoint from each other, respectively, for the message.

Alternatively, the processor 450 may perform encryption by directly using the public key in a state of multiplying the message and the scaling factor. In this case, an error calculated in the encryption process may be added to a result value obtained by multiplying the message and the scaling factor.

Further, the processor 450 may generate the homomorphic ciphertext so that a length of the ciphertext corresponds to a value of the scaling factor.

Further, once the homomorphic ciphertext is generated, the processor 450 may store the homomorphic ciphertext in the memory 420 or control the communication device 410 to transmit the homomorphic ciphertext to another device according to a request from the user or a predetermined default command.

Meanwhile, according to an embodiment of the present disclosure, packing may be performed. In a case of using the packing in the homomorphic encryption, it is possible to encrypt multiple messages to a single ciphertext. In this case, when the calculation apparatus 400 performs a calculation for each ciphertext, calculations for multiples messages are performed in parallel. As a result, calculation loads are greatly reduced.

For example, in a case where a message is constituted by a plurality of message vectors, the processor 450 may convert the message into a polynomial capable of encrypting the plurality of message vectors in parallel, and multiply the polynomial by a scaling factor, thereby performing the homomorphic encryption by using the public key. As a result, the processor 450 may generate a ciphertext in which the plurality of message vectors are packed.

Further, in a case where the homomorphic ciphertext needs to be decrypted, the processor 450 may generate a deciphertext in a polynomial form by applying the secret key to the homomorphic ciphertext, and generate the message by decoding the deciphertext in a polynomial form. The generated message here may include the error as mentioned in the description of Expression 1.

Further, the processor 450 may perform a calculation for the homomorphic ciphertext. For example, the processor 450 may perform a calculation such as addition, subtraction, or multiplication while maintaining an encrypted state of the homomorphic ciphertext. Here, the multiplication may be the modular calculation and may be performed in a manner as described later.

Meanwhile, in a case where the homomorphic ciphertext is generated by the above-described RNS method, the processor 450 may perform addition and multiplication for each basis in the generated homomorphic ciphertext.

Meanwhile, once the calculation is completed, the calculation apparatus 400 may detect data of an effective area from calculation result data. For example, the calculation apparatus 400 may detect data of the effective area by performing rounding processing on the calculation result data.

Here, the rounding processing means rounding off of the message in an encrypted state, which may also be referred to as rescaling. For example, the calculation apparatus 400 may eliminate a noise area by multiplying each component of the ciphertext by Δ⁻¹ which is a reciprocal number of the scaling factor and rounding off a result thereof. The noise area may be determined to correspond to the value of the scaling factor. As a result, a message of the effective area without the noise area may be detected. Since the rounding processing is performed while maintaining the encrypted state, although an additional error occurs, a value of the error is small enough to be ignored.

Further, the modular multiplication as described above may be used for the above-described rounding processing.

In a case where the calculation apparatus 400 supports the RNS-HEAAN, when a weight of any one of the plurality of bases exceeds a threshold, the processor 450 may rescale the homomorphic ciphertext by performing the message rounding-off processing on each of the plurality of bases in the generated homomorphic ciphertext.

Further, in a case where a weight of an approximate message in the calculation result ciphertext exceeds a threshold, the calculation apparatus 400 may expand a plaintext space of the calculation result ciphertext. For example, in a case where q is smaller than M in Expression 1, since M + e (mod q) has a different value from that of M + e, decryption may not be performed. Therefore, a value of q needs to be always larger than M. However, as the calculation proceeds, the value of q is gradually decreased. The expansion of the plaintext space means changing the ciphertext (ct) into a ciphertext with a larger modulus. The operation of expanding the plaintext space may also be referred to as rebooting. As the rebooting is performed, the calculation for the ciphertext may become possible again.

Meanwhile, homomorphic encryption, decryption, addition, multiplication, rescaling, rebooting, or the like, based on the ring-LWE may be implemented by a calculation of elements of a polynomial ring

$${R}_{q} = \frac{{Z}_{q} \left[X\right]}{\left({X}^{n} + 1\right)} .$$

Among the above-described calculations such as encryption, decryption, polynomial multiplication, and rebooting, the polynomial multiplication is the most time consuming calculation. In particular, the polynomial multiplication is performed about five times while performing a Mult algorithm that is most frequently used, and therefore, it is important to speed up the corresponding calculation.

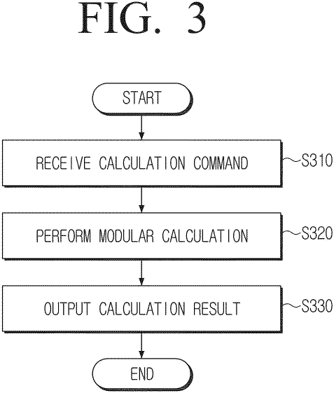

FIG. 3 is a flowchart for describing a ciphertext calculation method according to an embodiment of the present disclosure.

Referring to FIG. 3, a modular calculation command for a plurality of ciphertexts may be received (S310). Such a command may be input from an external device or may be directly input in the calculation apparatus. Further, the calculation command may be a command for message encryption or homomorphic ciphertext calculation.

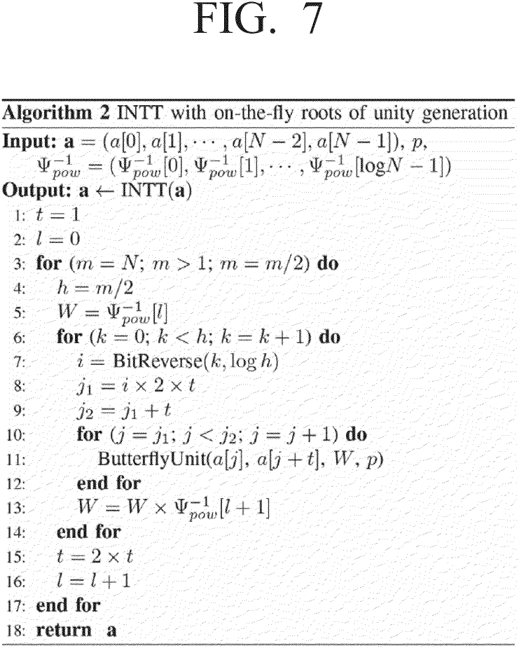

Then, the modular calculation for the plurality of ciphertexts may be performed by using a plurality of predetermined prime number information (S320). Here, each of the plurality of prime number information may be expressed by a combination of exponentiations of 2. An example of the prime number information is illustrated in FIGS. 5 or 6. Meanwhile, in a case where all the prime number information used for the modular calculation are stored in the memory, a large amount of memory resources are required. Therefore, it is sufficient if only some prime number information are stored, and prime number information necessary for the next cycle is generated by using the stored prime number information and previously used prime number information for each cycle. Such an operation for generating the prime number information (or square root information) will be described later with reference to FIG. 7.

Then, a calculation result may be output (S330). For example, the calculation result may be output to a device that has requested the calculation. Meanwhile, in a case where the above-described calculation command is a partial command required to perform an entire command such as message encryption, the calculation result may be transferred to another operator (or calculation program).

As described above, in the ciphertext calculation method according to the present disclosure, the calculation is performed using prime number information expressed by a combination of exponentiations of 2. Therefore, the calculation may be performed at a high speed. Further, in an implementation example, not all the prime number information are stored, but only some prime number information are stored, and the remaining prime number information are calculated by using the pre-stored prime number information for each cycle. Therefore, it is possible to perform the calculation only with a small amount of memory resources.

Hereinafter, a first modular calculation method for the homomorphic ciphertext will be described.

The first modular calculation method (ModMult) may be expressed as the following Expression 9 in which a value obtained by multiplying [A/q] and q is subtracted from A.

$$A \left(mod q\right) = A - \left⌊\frac{A}{q}\right⌋ \times q$$

Here, A denotes a ciphertext (or polynomial) and q is an element for a modulus.

ModMult (or modulus calculator) for performing such a calculation may include a first multiplier, a second multiplier, a third multiplier, a shift register, and a subtractor. Such a modulus calculator may be the calculation apparatus of FIG. 2, or may be one calculation module in a field programmable gate array (FPGA). Hereinafter, for convenience of explanation, modulus multiplication for two ciphertexts will be described, but in an actual implementation, modulus multiplication for polynomials, rather than the ciphertexts, may be used. Further, a different expression (a calculation including multiplication for the homomorphic ciphertext) from Expression 9 described above may be applicable.

The first multiplier may perform first multiplication of a first ciphertext A (or a first polynomial) and a second ciphertext B (or a second polynomial). Here, the first multiplier may be a full multiplier (Full-lntMult) which outputs a multiplication result V of 2n bits by using the first ciphertext A of n bits and the second ciphertext B of n bits.

The second multiplier may perform second multiplication of reciprocal number information T corresponding to one prime number information q of the plurality of prime number information, and a first multiplication result U. Specifically, the second multiplier (IntMult2) may perform an operation of multiplying a significant bit of the output of the first multiplier by T scaled to ⅟q.

For example, since a coefficient q of the third multiplier as described later is applied only to a significant bit of the output value of the second multiplier, the second multiplier may be an Upper Half (U_{H})-lntMult which outputs a multiplication result W of n bits by receiving two ciphertexts of n bits. Further, the reciprocal number information is a number that results in 1 when being multiplied by the prime number information, that is, a reciprocal (⅟q) of the prime number, and the corresponding value may be stored in a lookup table in advance or may be calculated using the base prime number information (or base square root information).

The third multiplier may perform third multiplication by using a second multiplication result W and one prime number information q. For example, since only a less significant bit of the output value of the third multiplier is multiplied by an output bit of the shift register, the third multiplier may be a Lower Half (L_{H})-IntMult which outputs a multiplication result W of n bits by receiving two ciphertexts of n bits.

Further, the shift register may delay the output value of the first multiplier and provide the delayed value to the subtractor. For example, the shift register may delay a less significant bit of the output value of the first multiplier and may be implemented by flip flops (FF). Therefore, the subtractor may subtract the output value of the third multiplier from the output value of the shift register and output the subtraction result.

As described above, the second multiplier and the third multiplier may each perform multiplication using the reciprocal number information T and the prime number information q.

Meanwhile, in the RNS-HEAAN, three types such as a basic modulus, a rescaling modulus, and a ModUp modulus are used and the modulus needs to be appropriate for 1 mod 2N in a case where the degree of the polynomial is N-1. Further, a prime number q and a prime number of which a reciprocal number T corresponding to the prime number has a low hamming weight may be expressed by a value obtained by addition and subtraction of three, four, or five exponentiations of 2 with different exponents as illustrated in FIGS. 5 or 6.

As such, since the prime number used in the present disclosure is expressed by a combination of exponentiations of 2, prime number multiplication may be performed only with a shift calculation, and addition and subtraction operations in a calculation process for the prime number and a reciprocal number of the prime number.

That is, the second multiplier and the third multiplier may each perform an individual shift calculation based on an exponent of each of a plurality of exponentiations of 2, and may perform the second multiplication and the third multiplication, respectively, by performing addition or subtraction of shift calculation results.

As such, a complicated prime number multiplication operation may be performed only with a shift calculation and addition/subtraction, and thus it is possible to implement a high-speed calculation.

Meanwhile, although a case where the modular multiplication is performed by receiving the ciphertext has been described above, in an actual implementation, various values may be input for the modular multiplication. That is, the modular multiplication may not only be used for the ciphertext calculation, but also be used to calculate values required for the encryption process or used in the scaling or decryption process, and any value used in the above processes, other than the ciphertext, may be used.

Hereinafter, a second modular calculation method for the homomorphic ciphertext will be described.

The algorithm of the second modular calculation method (ModMult) is similar to that of the first modular calculation method, but is different from that of the first modular calculation method in that a pre-calculated value is used. Specifically, a “pre-calculated value B′ obtained by multiplying a reciprocal number corresponding to one prime number information and the second ciphertext” may be stored and used. Such a pre-calculated value B′ is an approximate value of B/q, and as B′ is used, A × B/q may be approximated to W.

Meanwhile, a method in which a value required for the calculation is calculated in advance, and the pre-calculated value is used at the time of the calculation to speed up the calculation has been described as the second modular calculation method. However, although such a method may speed up the calculation, a large storage space is required. In this regard, a method in which the modulus calculation may be performed using a relatively small storage space while speeding up the calculation will be described below. First, a relationship between the above-described modulus calculation, a number theoretic transform (NTT) calculation, and an inverse NTT (iNTTiNTT) calculation will be described for describing the algorithm.

Hereinafter, w will be referred to as an N^{th} modulo for a modular prime number p. In other words, w^{N}≡ 1 (mod N). A primitive N^{th} root is an N^{th} root generated by multiplying all N^{th} roots. It is defined that, for the primitive Nth root, it is required to perform discrete Fourier transform (DFT) on an N-sized vector. It is known that an N^{th} root for p exists when p ≡ 1 (mod N).

The operation is performed on a ring

$$\frac{{z}_{p} \left[x\right]}{\left({x}^{N} + 1\right)}$$

(here, N is a power, and p is a prime number) in a lattice-based ciphertext including the homomorphic ciphertext. Multiplication on the ring corresponds to negative wrapped convolution, whereas an NTT-multiplication-iNTTiNTT paradigm corresponds to multiplication on a ring

$$\frac{{z}_{p} [ x ]}{( {x}^{N} - 1 )}$$

, that is, typical convolution.

An NTT/iNTTiNTT algorithm may be slightly modified to efficiently perform the multiplication on the ring

$$\frac{{z}_{p} [ x ]}{( {x}^{N} + 1 )}$$

. In order to use such a modification, the modulus p needs to satisfy p ≡ 1 (mod 2N), but for general NTT/iNTTiNTT, it is required that p ≡ 1 (mod N). Therefore, a framework modified for efficiency will be described in the present disclosure, and will hereinafter be referred to as the modified NTT/iNTTiNTT algorithm.

An efficient iNTTiNTT operation for negative convolution is illustrated in Algorithm 4. Such an efficient iNTTiNTT operation will be described below with reference to FIG. 4.

FIG. 4 is a diagram for describing an iNTTiNTT algorithm according to a first embodiment of the present disclosure. A rescaling process is omitted in FIG. 4 to simplify the description, but the rescaling process may be added in an actual implementation.

Referring to FIG. 4, a list (which is indicated by

$$ψ \left({- 1}_{r e v}\right)$$

of negative exponents of a fixed primitive (2N)^{th} radical root (Ψ) in bit-reversed order may be input. More specifically,

$${ψ}_{r e v}^{- 1} \left[i\right]$$

includes

$${ψ}^{- j} ,$$

in which j is a bit reversal of i.

In general, the NTT/iNTTiNTT may be performed using BUs, which are building blocks. Hereinafter, the BUs may also be referred to as functional blocks, building blocks, and the like. Here, the functional block (ButterflyUnit function) of FIG. 4 is a[j], a[j+t], W, p, and a[j] - a[j + t](mode p) and (a[j] + a[j + t]) · W(mod p) may be calculated and may be stored in a[j] and a[j+t], respectively.

When the number of input samples is N, the number of stages of the NTT is log N, and each stage may include BUs of

$$\frac{N}{2} r a d i x - 2 B U s .$$

Therefore, the total number of BUs required is B

$$\frac{N}{2} \times log N .$$

For example, in a case where N is 8 and the number of stages is 3, 12 BUs are required. Here, the sample refers to input data provided to the calculator (or BU), and may be a homomorphic ciphertext, a polynomial, or the like.

Hereinafter, an operation for an RNS homomorphic calculation (hereinafter, referred to as the RNS-HEAAN) will be described.

The RNS-HEAAN is a method in which R_{qi} (qᵢ = Δⁱ) which is an existing ciphertext space is substituted with R_{qi} (qᵢ = Πpᵢ, Δⁱ), pᵢ ≈ Δ) to resolve the problem that a method such as the Chinese remainder theorem is not applicable to the existing HEAAN. Such RNS-HEAAN is a major solution for homomorphic encryption because approximate calculation with a fixed point is supported. In particular, the RNS-HEAAN enables a parallel calculation because a large coefficient of a polynomial is divided into small coefficients to perform a calculation.

Homomorphic multiplication (HomeMult) is a frequently used homomorphic calculation, but it takes a lot of time, which is the biggest obstacle in actual use of homomorphic encryption-based applications. The biggest bottleneck here is that high-order polynomial ring multiplication is still slow even with the NTT/iNTTiNTT.

This phenomenon is the same in the RNS-HEAAN, but the RNS-HEAAN has an additional function that makes a difference from the existing situation. Basically, an input coefficient of a polynomial in the RNS-HEAAN is converted into an NTT domain in advance for an efficient homomorphic calculation. However, unconverted coefficients also require the homomorphic multiplication.

Hereinafter, it is assumed that two ciphertexts, (ct₁ = (a₁, b₁ = a₁s + m₁ + e₁) and ct₂ = (a₂, b₂ = a₂s + m₂ + e₂), are multiplied on a cyclotomic ring (R²_{Q}). Here, s, mᵢ, eᵢ, and Q are a sample polynomial from an Xkey, a message, an error, and a large modulus

$${\text{(}}^{Π} i {=}^{l} 0 {}^{{q}_{i}} )$$

respectively.

In a case where the secret key is set to (-s, 1), the product of the ciphertexts may be calculated using the following Expression.

$$< {\text{Ct}}_{\text{mult,}} {\text{sk> = a}}_{1} {\text{a}}_{2} {\text{s}}^{2} {\text{- (a}}_{1} {\text{b}}_{2} {\text{+ b}}_{2} {\text{b}}_{1} ) {\text{s + b}}_{1} {\text{b}}_{2}$$

Here, <·, ·> represents the dot product of two vectors.

When the first term of Expression 11 is linearized and the large error (a₁b₁e_{swk}) is scaled down to

$$1 / \text{P} \left(= 1 / Π {}_{i = 1}^{k} {p}_{i}\right) ,$$

a switching key (swk) on a cyclotomic ring R²_{PQ} may be defined as the following Expression 12.

$$\frac{1}{P} < s w k , s k > = {s}^{2} + \frac{{e}_{s w k}}{P}$$

Here, e_{swk} may refer to as an error caused when the switching key is used for decryption. A domain on a₁, a₂ R²_{Q} may be converted into an R²_{PQ} domain to multiply the switching key. Such a conversion process may be referred to as basis conversion, and requires the iNTTiNTT to inversely convert a₁a₂ on the NTT domain. After this conversion, the NTT is reapplied to the converted a₁a₂.

Partial moduli on (qᵢ, pᵢ) may be classified into the following three types.
1. Base modulus (q₀): Each time the homomorphic multiplication is performed, the number of qⁱ decreases by 1, a circuit depth decreases by 1, and this module is the last remaining modulus.
2. Rescale modulus (q₁, where 1 ≤ i ≤ l): The number of rescale moduli represents the circuit depth. In general, it is advantageous to make the number of rescale moduli large so that the bootstrapping is not used as much as possible.
3. Mod-up modulus (pᵢ, where 1 ≤ i ≤ k): The mod-up modulus is used to reduce the size of an error occurring during the homomorphic multiplication.
Hereinafter, parameters for the bootstrapping of the RNS-HEAAN will be described.

A homomorphic encryption scheme uses an error to encrypt a message. However, each time a calculation on the homomorphic ciphertext is performed, the internal error increases. In particular, the internal error rapidly increases each time the homomorphic multiplication is performed. Moreover, when the size of the error exceeds a certain level, it is impossible to obtain a correct message by decryption. Here, the number of times the homomorphic multiplication is performed before reaching the certain level (or threshold) is referred to as the circuit depth.

As the bootstrapping for resetting the error and the circuit depth is performed, the homomorphic calculation may be performed an unlimited number of times for the homomorphic ciphertext. However, since the bootstrapping is performed very slowly, a practical calculation may not be performed. Therefore, it is necessary to increase the speed of the bootstrapping, and the following two methods may be considered to increase the speed. The first method is a method of increasing a processing speed of the bootstrapping, and the second method is a method of increasing a bootstrapping interval (for example, the circuit depth). Hereinafter, the second method will be described first.

General bootstrapping consumes a circuit depth of 15 to 20. When the bootstrapping is performed, the circuit depth required for the bootstrapping is subtracted from an initial circuit depth. For a practical design, the initial circuit depth needs to be set to approximately 40, so that the circuit depth after the bootstrapping becomes 20 to 25. Hereinafter, parameters according to the present disclosure for implementing such an initial circuit depth will be described with reference to Table 1.

TABLE 1

| | λ | dnum | N | l+1 | k | log Q | logP | logP Q | logq₀ | logqᵢ | logpᵢ |
|---|---|---|---|---|---|---|---|---|---|---|---|
| RNS-HEAAN 1 | 73 | 1 | 2¹⁵ | 11 | 12 | 611 | 660 | 1271 | 62 | 55 | 55 |
| RNS-HEAAN2 | 108 | 4 | 2¹⁶ | 24 | 6 | 109 0 | 273 | 1363 | 62 | 45 | - |
| RNS-HEAAN 3 | 105 | 7 | 2¹⁶ | 28 | - | 127 0 | 182 | 1452 | 62 | 45 | - |
| HEAX set-A | 128. 1 | - | 2¹² | 2 | - | - | - | 109 | - | - | - |
| HEAX set-B | 128. 5 | - | 2¹³ | 4 | - | - | - | 218 | - | - | - |
| HEAX set-C | 128. | - | 2¹⁴ | 8 | - | - | - | 438 | - | - | - |
| | 1 | | | | | | | | | | |
| Our SET-A | 129. 8 | 2 | 2¹⁷ | 36 | 16 | 188 2 | 992 | 2874 | 62 | 52 | 62 |
| our SET-B | 127. 3 | 3 | 2¹⁷ | 42 | 12 | 219 4 | 744 | 2938 | 62 | 52 | 62 |

Referring to Table 1, it may be appreciated that a security parameter (λ) of approximately 80 is widely used in the existing technology. However, the security parameter needs to be increased to 128 in that related research on personal data is diversifying. Specifically, referring to Table 1, it may be appreciated that the security parameter in the existing RNS-HEAAN scheme does not reach 128. In the existing HEAX scheme, the security parameter reaches 128. However, the scheme does not consider the bootstrapping, and thus, the homomorphic multiplication is allowed to be performed only eight times. Meanwhile, among the parameters according to the present disclosure, parameters most different from the existing ones are the number of evaluation keys and dnum. Referring to the second row, it may be seen that the size of logP and the size of logQ are set similarly. However, logQ needs to be increased to increase the initial circuit depth to approximately 40, but there is a limit to the size of logPQ for security. To solve such a problem, the ciphertext may be decomposed by increasing dnum. As a result, logQ is set to LogP × dnum. That is, when dnum increases, the size of a memory in which the evaluation key is to be stored increases. Therefore, the evaluation key may not be stored in an internal memory. In addition, the NTT needs to be performed a number of times corresponding to a multiple of dnum, which causes a large delay. Accordingly, in the present disclosure, 2 or 3 is selected as a value of dnum that may optimize an increase in initial circuit depth and an increase in evaluation key.

In addition, in the present disclosure, the base modulus (log q₀) is set to 62 to preserve the precision of a message at the time of decryption, and the rescale modulus (log qᵢ) is set to 52 to satisfy the following two conditions. The first condition is that the rescale modulus needs to be large enough to perform the approximate calculation of the RNS-HEAAN, and the second condition is that the rescale modulus is sufficient to find many lightweight prime numbers. As these prime numbers are used, it is possible to speed up modMult by substituting the homomorphic multiplication with a bit shift calculation and addition.

There is a small limit in determining the size of the mod-up modulus (log pᵢ). The product of the mod-up moduli needs to be larger than a certain value. That is, each mod-up modulus needs to be small, and the number of mod-up moduli needs to be increased. Further, since a 62-bit modulus operator for the base modulus is already possessed, 62 is selected as the size of the mod-up modulus.

The prime number information used for the base modulus/rescale modulus and the mod-up modulus is as illustrated in FIGS. 5 and 6.

FIG. 5 is a diagram illustrating an example of a first prime number set according to an embodiment of the present disclosure.

Referring to FIG. 5, 42 prime numbers are shown, and each of the 42 prime numbers is expressed by a combination of exponentiations of 2, in which the exponent does not exceed 61. Here, the first prime number (i = 0) is a prime number used in the base modulus and has a maximum size of 62 bits, and prime numbers larger than 1 and prime numbers smaller than l are prime numbers used in the rescale modulus. In a case where i > 1, it may be appreciated that all prime numbers have a size smaller than 2⁵². As such, the prime number that may be expressed by a combination of exponentiations of 2 is used in the present disclosure, and thus multiplication of the prime number may be performed only with a shift calculation, and addition and subtraction.

Meanwhile, when storing information on the prime number described above, only information regarding an exponentiation included in the prime number may be stored without storing the prime number itself. Information indicating that 51 and 0 have a value of +1 and 26 has a value of -1 may be stored as prime number information for a prime number (i = 0). By storing the prime number information in this way, a prime number may be stored with bits smaller than 2⁶¹ bits. The above-described expression method is merely an example, and the prime number information may be stored in a method different from the above-described method. In particular, a prime number including only three to five exponentiations is used in the present disclosure, only a small amount of resources are required to store the prime number information.

FIG. 6 is a diagram illustrating an example of a second prime number set according to an embodiment of the present disclosure.

Referring to FIG. 6, 16 prime numbers are shown, and each of the 16 prime numbers is expressed as a combination of exponentiations of 2, in which the exponent does not exceed 61. As such, the prime number that may be expressed by a combination of exponentiations of 2 is used in the present disclosure, and thus multiplication of the prime number may be performed only with a shift calculation, and addition and subtraction at the time of a mod-up calculation.

In FIGS. 5 and 6, only prime numbers are shown, that is, a scaled value (that is, a reciprocal number) of the corresponding prime number is not shown. However, a value (that is, a reciprocal number) expressed as an exponentiation of 2, which may result in 1 by being multiplied by the scaled value, exists. Such a prime number and a reciprocal number thereof have a hamming weight of 5 or less, which enables spatially efficient hardware design.

Returning to Table 1, in the present disclosure, an N parameter having a value of 2¹⁷ is used. As such, since the value of the N parameter has increased than before, an execution time of the NTT and an execution time of the iNTT may increase. Therefore, a hardware system design method for achieving higher NTT and iNTT calculation speeds than before, despite the increase in value of the N parameter will be described below.

As described above, a square root is required in performing the NTT. For a fast calculation, all square roots may be stored and used. However, such a method has a problem in that a required space in a memory increases linearly together with N and (l + 1) · k.

That is, in a case where N and/or (l + 1) · k becomes very large, it may become impossible to store all prime numbers (or radical roots) in the internal memory. In particular, since the internal memory of the FPGA has a limited space unlike the typical case, a method for storing necessary prime number information without exceeding the allowed capacity of the internal memory of the FPGA is required. For example, in a case where SET-B in Table 1 is used for the iNTT, a total of 400 MB (≈ 62b * 17 + 52b * 41) * 2¹⁷) of capacity of the internal memory is required to store all square roots.

Therefore, a method in which only some prime number information (or some square root information) are stored instead of storing and using all prime number information (or all square root information), and necessary prime number information (or necessary square root information) may be calculated based on the information and used in a calculation process is required. Hereinafter, a detailed configuration and method for such an operation will be described. The method according to the present disclosure achieves a balance between calculation and storage. In addition, such a modification does not asymmetrically increase the amount of calculation. For example, even in a case where the changed algorithm is used, the calculation cost is still O(NlogN), which is the same as before. Conversely, the storage space is reduced from o(N) bits to O(logN) bits.

Hereinafter, the above-described method will be described in detail with reference to FIG. 7.

FIG. 7 is a diagram for describing an iNTT algorithm according to a second embodiment of the present disclosure. Similarly to FIG. 4, the rescaling process is omitted also in FIG. 7 to simplify the description, but the rescaling process may be added in an actual implementation.

Referring to FIG. 7, a list of (-2ⁱ)^{th} powers of a fixed primitive (2N)^{th} radical root Ψ is used, and the list is referred to as

$${ψ}_{p o w}^{- 1} .$$

More specifically,

$${ψ}_{p o w}^{- 1} \left[i\right]$$

includes

$${ψ}^{- {2}^{i}} .$$

BitReverse(k, log h) of FIG. 7 is to convert a bit value of k into a log h bit integer.

A difference from Algorithm 1 illustrated in FIG. 4 is as follows. i)

$${ψ}_{p o w}^{- 1} \text{is}$$

used instead of

$${ψ}_{r e v}^{- 1}$$

to reduce the size of an input, ii) bitwise conversion of Line 7 of FIG. 7 is performed instead of taking a pre-stored square root, and iii) a necessary square root is generated and used for update rather than pre-calculating all the square roots.

Meanwhile, a different square root is required for each iNTT stage, and according to the present disclosure, a square root necessary for each stage is generated in parallel. Such an operation will be described below.

The NTT and the iNTT have almost the same system design, except that the progress direction is different, and the scaling process is added in the iNTT. In this regard, the NTT and the iNTT may use the same circuit, and only an implementation example of the iNTT will be described below.

FIG. 8 is a diagram illustrating a configuration of a BU according to the first embodiment of the present disclosure. Specifically, FIG. 8 illustrates a radix-2BU for the iNTT.

Referring to FIG. 8, a BU 800 may include a modular subtractor 810, a modular adder 820, and a modular multiplier 830. A and B represent input samples, A′ and B′ represent output samples, and W represents square root information.

The modular subtractor 810 may receive A and B, and may output a modular subtraction result of the two input samples to the modular multiplier.

The modular adder 820 may receive A and B, and may output a modular addition result of the two input samples to A′.

The modular subtractor 810 and the modular adder 820 have the same system design as a general subtractor and adder, and the calculation result of the subtractor or adder is output after a delay of two cycles.

The modular multiplier 830 receives the output of the modular subtractor 810 and W, and outputs a modular multiplication result thereof. Here, the modular multiplier 830 may utilize a fully pipelined lightweight modular system design. A detailed configuration of such a modular multiplier has been described above with reference to FIG. 3, and thus an overlapping description will be omitted.

The output of the calculation result of the modular multiplier 830 used in the present disclosure requires one more cycle than before in that the maximum hamming weight and the scaled inverse value in the modular multiplier according to the present disclosure are larger by 1 than before. Therefore, the calculation result is output after a delay of 21 cycles. Here, the delay cycle is merely an example and may be different from the above-described value according to an applied hardware environment and an implementation algorithm.

Meanwhile, in a case where the above-described BU is used for the NTT calculation, the prime number information may be provided to the modular multiplier instead of the square root information, and the calculation result of the modular multiplier may be applied to the modular subtractor or the modular adder.

Hereinafter, the operation of the above-described BU will be described in detail with reference to an operation timing diagram.

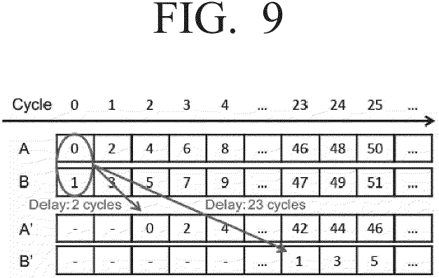

FIG. 9 is a diagram for describing an operation timing of the BU of FIG. 8.

Referring to FIG. 9, it may be appreciated that the first output value A′ is output two cycles after the two input values A and B are input, and the second output value B′ is output 21 cycles after the first output value A′ is input to the modular multiplier 830.

Meanwhile, it may be appreciated that two input samples are continuously input every cycle, and an output is also outputted every cycle after a predetermined delay, because the BU according to the present disclosure is designed as a complete pipeline.

In a case where multiple BUs are connected in series, the output sample may be the input sample of the next BU.

Hereinafter, a case where a plurality of BUs are grouped will be described.

It is necessary to use a plurality of BUs at the same time to improve the speed of the iNTT on the FPGA. However, since each BU includes an expensive modular operator, it is difficult to employ N/2*logN BUs when N is very large.

Therefore, it is necessary to use a reasonable number of BUs, and a rational BU arrangement method will be described below. The first method is to arrange a plurality of BUs in parallel on the same stage, and the second method is to arrange a single BU (or several BUs) for each stage and arrange a plurality of BUs in series.

The first method is intuitive and the order of intermediate data is simple. However, since the BUs are arranged in parallel, high input/output and memory bandwidth are required for a short time. Therefore, in the present disclosure, an example using the second method will be described. However, the first method may be used in an environment in which the problem of high input/output and memory bandwidth may be solved.

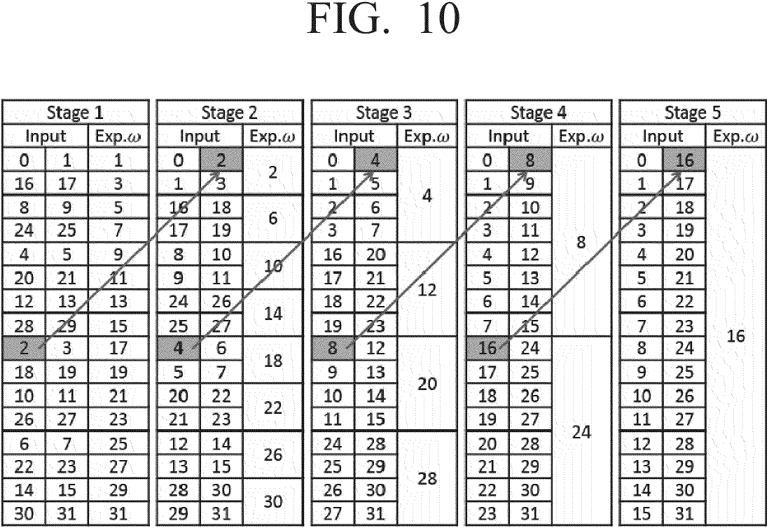

FIG. 10 is a diagram for describing an operation timing in a case where the BU is operated with the algorithm of FIG. 7. Specifically, FIG. 10 illustrates an operation timing in a case where a plurality of BUs are arranged in series when N is 32.

Referring to FIG. 10, the stage order is shown in the first row, and an index of an input sample is shown in the first column and the second column of each stage.

An exponent is shown for a square root in the third column of each stage, the exponent increasing in fixed units and being referred to as an update constant. It may be appreciated that the update constant increases exponentially for a higher stage.

Comparing the first stage and the second stage, the first case where the output of the first stage is input to the second stage is indicated by an arrow.

As such, each stage has a dependency, and thus, delays are accumulated. Accordingly, in order to solve such a delay, the BU may be additionally arranged for each stage. Specifically, since the number of DSP slices is limited by the lookup table and flip-flops, the number of BUs (hereinafter, referred to as c) for each stage may be determined based on the total number of available DSP slices. Then, an input sample sequence for each stage may be divided by c, and the divided partial sequence may be input to each BU.

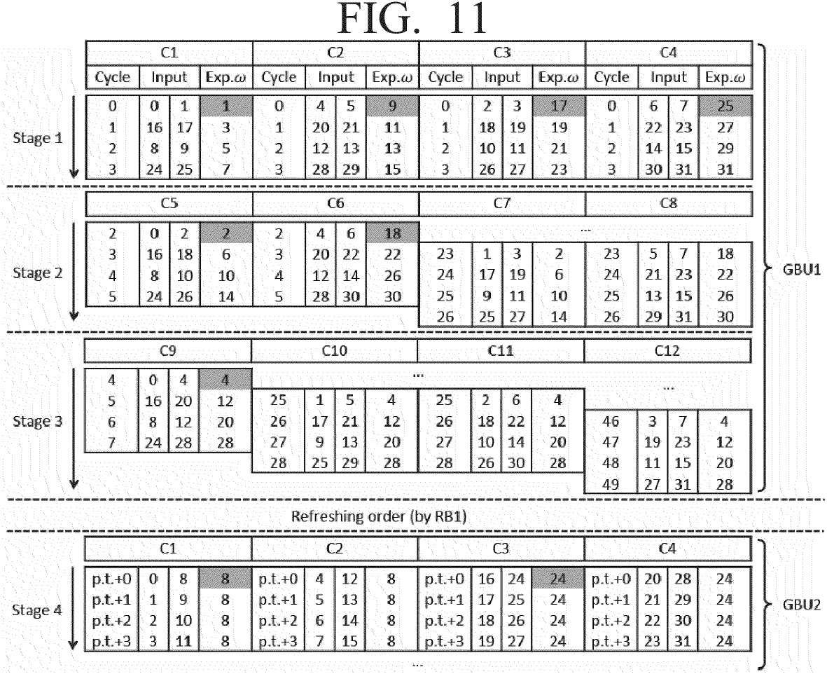

FIG. 11 is a diagram for describing an operation timing in a case where a plurality of BUs are arranged in parallel.

Referring to FIG. 11, in the illustrated example, c is 4, and ci denotes the i-th BU core. Input samples of 0, 2, 4, and 5 in Stage 1 are processed in modAdd of C1, C3, C2, and C4 respectively, and thus, C5 and C6 of Stage 2 are started after a delay of two cycles. Meanwhile, input samples of 1, 3, 5, and 7 are applied in modSub and modMult, and thus, C7 and C8 of Stage 2 are started after a delay of 23 cycles. The BU core of the subsequent Stage 3 may operate in the same manner.

Since we aim to have a large N value as described above, the cumulative delay in Stages 1 to 3 is negligible, and the above-mentioned throughput is eight samples/cycles.

On the other hand, the BU core of the stage 4 receives input samples with an index difference of 8, but each input sample may be calculated after N/(2*2*4) cycles (where N is 2¹⁷). Therefore, a reordering buffer for changing the order is required. Between two reordering buffers, the BU core may include a BU group (BUG). The number of stages in a single GBU and the number of GBUs in the entire iNTT design may be calculated as 1 + logc and [logN/(1 + logc)], respectively.

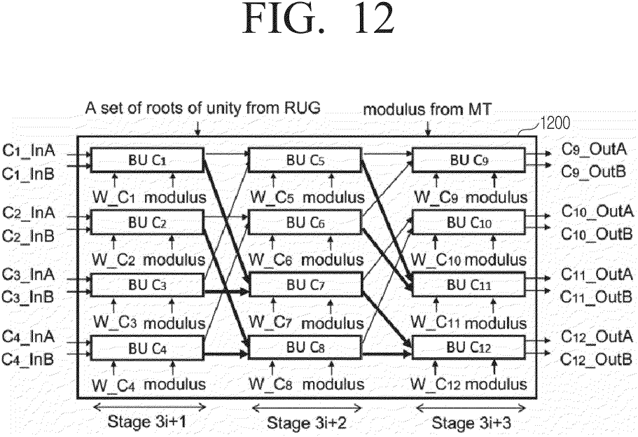

FIG. 12 is a diagram illustrating a configuration of the GBU according to an embodiment of the present disclosure. Specifically, FIG. 12 is a diagram illustrating the configuration of the GBU in a case where c described above is 4. A case where c is 4 is described in this example, but in an actual implementation, the GBU may be configured in such a way that c has a difference value.

Referring to FIG. 12, one GBU 1200 includes 12 BUs. Specifically, the GBU may include three stages, and each stage may include four BUs. Such a 3*4 arrangement is only an example, and in an actual implementation, the number of stages and the number of BUs for each stage may vary depending on design parameters.

An output of modular multiplication (ModMults) of each BU is indicated by a bold line. The GBU receives eight input samples and 12 square roots every cycle. Eight samples are generated after a delay of one cycle, and may be delivered to an RB every cycle.

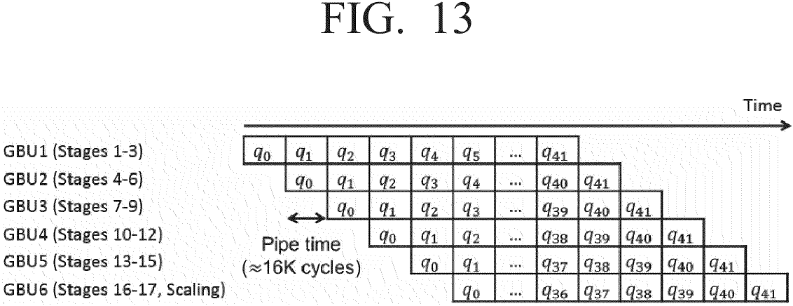

An additional parallel arrangement operation may be used to further improve throughput. This will be described with reference to FIG. 13.

FIG. 13 is a diagram for describing an operation timing in a case where the iNTT is designed with SET B of Table 1.

Referring to FIG. 13, in the homomorphic multiplication of the RNS-HEAAN, the base modulus and the rescale modulus are used only in the iNTT, and 42 moduli as illustrated in FIG. 5 may be used. Each pipe time is required to be approximately 16 K cycles (about 16 K*(5 + 42)) for the iNTT calculation for a polynomial.

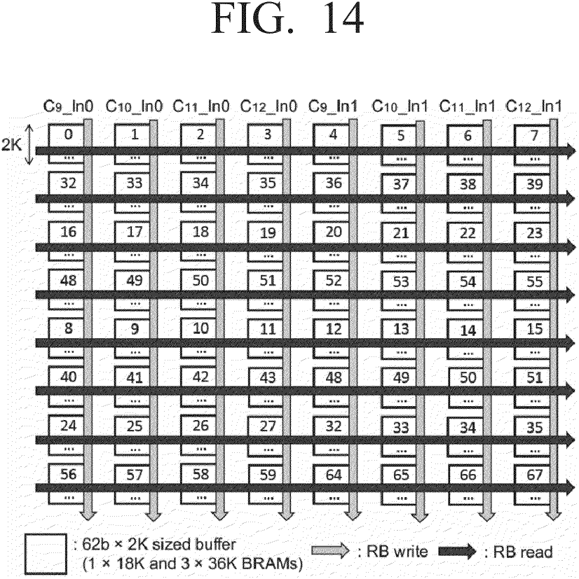

The reordering buffer will be described below with reference to FIG. 14.

FIG. 14 is a diagram illustrating a configuration of the RB according to an embodiment of the present disclosure.

Referring to FIG. 14, the i-th RB may store an output sample generated in the i-th GBU and transfer a reordered sample to the i+1-th GBU.

In FIGS. 11 and 12 above, eight samples may be generated in a first GBU cycle. In a case of performing reordering, these samples may be stored in a buffer in each RB. Further, each of four BU cores of Stage 4 may read the eight samples with an index difference of 8. For example, samples indexed by 0, 8, ..., 48, and 56 may be read in a first cycle.

In a case where a sample generated in the BU core is stored in a BRAM to use the sample in the BU core that has generated the sample, it is necessary to use a BRAM having a large bandwidth. In this case, the use efficiency of the BRAM deteriorates. Therefore, an output sample sequence from each BU core may be written to eight separate BRAM buffers. Here, the BRAM executes a storage function as an internal cache in the FPGA and has a higher read/write speed than the general DDR method.

Although not illustrated, a double buffering technique capable of simultaneously performing reading/writing may be used. Accordingly, a BRAM buffer having a size of 128 (= 2*8*8) 62-bit *2K may be included in each RB.

When transferring to eight BU cores in the stage 4, eight samples may be read horizontally as illustrated in FIG. 14. The next RB may vertically read 8ⁱ⁻¹ samples from the same buffer in the vertical direction, and then horizontally transfer the 8ⁱ⁻¹ samples to the next buffer.

Hereinafter, an operation of a prime number generator according to an embodiment of the present disclosure will be described.

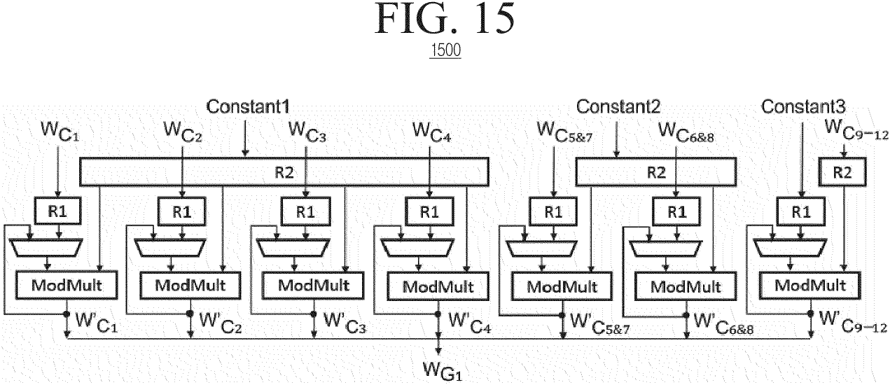

FIG. 15 is a diagram illustrating a configuration of the prime number generator according to an embodiment of the present disclosure. Hereinafter, although it is expressed that a prime number is generated for ease of explanation, the above-described prime number generator may be used even in a case of generating a square root corresponding to the prime number (that is, in a case of the iNTT operation). That is, the prime number generator may not only generate a prime number, but also generate a square root corresponding to the prime number. In this case, the prime number generator may also be referred to as a square root generator.

For reference, FIG. 15 illustrates an example of the prime number generator in a case where N is 2¹⁷ and c is 4, but the prime number generator may have a different configuration to support other N values and other c values in an actual implementation.

Referring to FIG. 15, a prime number generator 1500 may generate all square roots (or all prime numbers) from base square roots (or base prime numbers) that are O(logN). Each GBU requires 12 square roots. Specifically, since C5 and C7, C6 and C8, and C9 to C12 each use the same square roots, the prime number generator may generate seven square roots. The respective square roots are represented by W_{C1}, W_{C2}, W_{C3}, W_{C4}, W_{C5&7}, W_{C6&8}, and W_{C9-12}.

The seven square roots include a group (W_{Gi}) of square roots, and may be transferred to the i-th GBU. At the same time, the seven square roots may be provided to the modulus calculation (ModMULTS) within an RUG, and after a corresponding square root is generated, a square root (or prime number) required for the calculation of the next cycle may be generated. Specifically, the prime number generator 1500 may generate square root information (or prime number information) to be used in the next cycle by using a square root and base square root information (or base prime number information) generated in the current cycle.

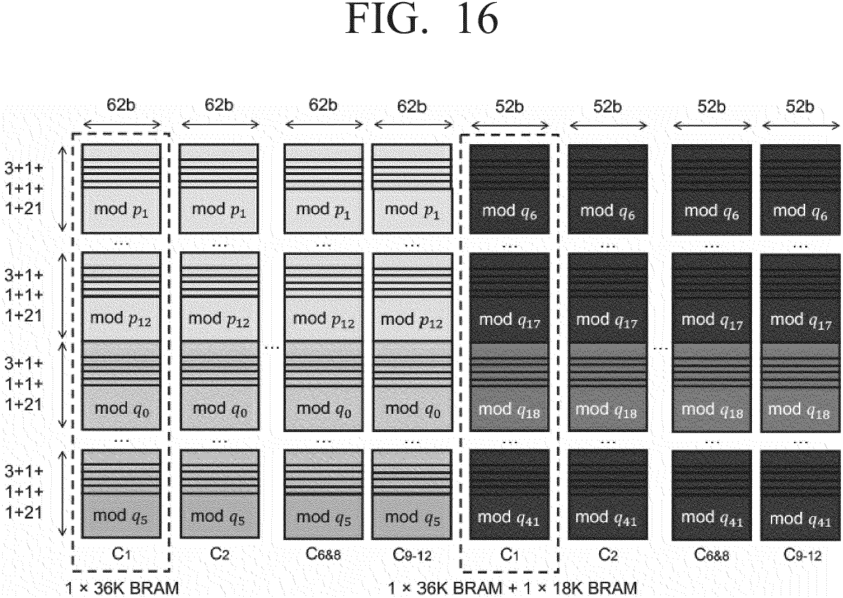

FIG. 16 is a diagram for describing an example of data stored in an internal memory according to an embodiment of the present disclosure.

Referring to FIG. 16, each different hatching represents a base square root used in a different module. As described above, each LUG requires seven base square roots. However, a delay of 21 cycles may occur due to changes in hardware system design of a ModMult RUG.

(i) A square root stored in a ROM during the delay is used as an input operand of ModMults to increase the number of square roots to be stored, and a square root generated by ModMults after the delay is used as an input operand. (ii) After the delay, the square root is generated in ModMults and may be used for an input calculation. Accordingly, a square root for a first GBU changes every cycle, 21 base square roots are thus required. Meanwhile, a square root for a second GBU changes every eight cycles, three base square roots may be stored. Finally, a third GBU, a fourth GBU, a fifth GBU, and a sixth GBU change every 64 cycles, and thus, only one base square root is required. 21 base square roots for the first GBU may be directly transferred to ModMULTS.

Meanwhile, a base square root for the other GBU is stored in a register marked as R1 to minimize the BRAM bandwidth, and may be used at the next modulus during the next pipeline. Similarly, the update constant may be read from the ROM (or the internal memory in the FPGA) and stored in a register marked as R2. Since the BU receives seven base square roots at the same time, the base square roots may be stored in seven ROMs (or internal memories, internal registers, internal buffers, or the like), respectively. Basically, base square roots for the mod-up modulus and the base modulus may be stored in a 62-bit ROM, and a base square root for the scale modulus may be stored in a 52-bit ROM.

However, a base square root for q₁ to q₅ may be stored in a 62-bit ROM to increase the use efficiency of the BRAM. Meanwhile, a different configuration may be used for Set-A of Table 1. Specifically, p₁ to p₁₆, q₀, and q₁ may be stored in a 62-bit ROM, and q₂ to q₃₅ may be stored in a 52-bit ROM.

Meanwhile, a bootstrapping parameter set according to the present disclosure has a modulus of 50 or more and a scaled inverse value. These values are stored in a modulus table (MT), and a pair corresponding to a pipeline time may be selected according to a selection signal for the first GBU and the RUG. Such a pair may be delayed in the register and provided to the next GBU and the RUG.

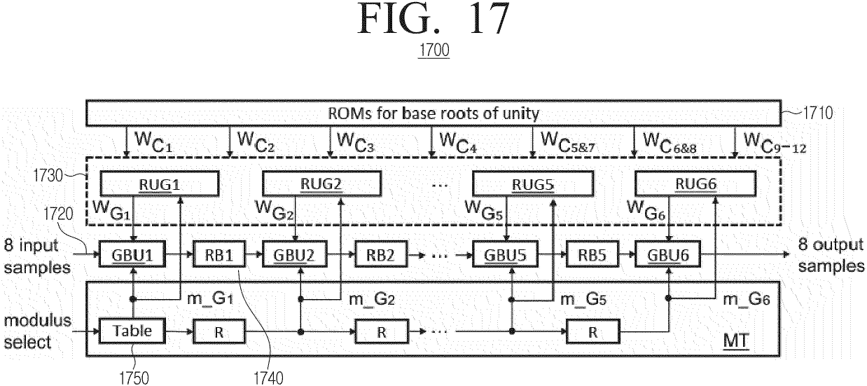

FIG. 17 is a diagram for describing a structure of a processor according to an embodiment of the present disclosure.

FIG. 17 illustrates an example of a case where c is 4. However, c may have a different value in an actual implementation. Specifically, c having a large value results in high throughput, short delay and less BRAM, but requires a number of DSP slices.

A hardware system 1700 that performs the iNTT according to the present disclosure may include an internal memory 1710, six GBUs 1720, five RBs 1740, six RUGs 1730, and one MT 1750. In particular, since the iNTT stage uses only six GBUs, the last stage may be used for scaling. Specifically, the BU in the last stage may be substituted with two ModMults, and a scaling constant may be input into ModMults instead of a square root.

Hereinafter, performance of the homomorphic calculation according to the present disclosure will be described.

The target platform is 1800 DSP slices, 132.9 Mbit BRAMs, 1M LUTs, and 2 M FFs. It is assumed that input samples are continuously fed into the iNTT design, and a time for data transmission through an I/O interface is hidden by pipeline scheduling.

TABLE 2

| Design | Chen | Roy | Ozturk | Proposed |
|---|---|---|---|---|
| Device | xc6slx100 | xczu9eg | xc7vc690t | xcvu190 |
| No. of samples | 2¹¹ | 2¹² | 215 | 2¹⁷ |
| No. of moduli | 1 | 6 | 41 | to 42 |
| Max. bit-width | 58 | 30 | 32 | 62 |
| fmax (MHz) | 210 | 200 | 250 | 200 |
| kLUT | 6 | 55 | 219 | 365 |
| kFF | 19 | 22 | 91 | 335 |
| DSP | 64 | 182 | 768 | 1332 |
| BRAM (KB) | 113 | 1746 | 869 | 10163 |
| Gbps | 4.43 | 1.45 | 20.60 | 88.65 |
| Mbps/DSP | 69.20 | 7.94 | 26.82 | 66.55 |
| Kbps/LUT | 703.59 | 26.01 | 93.98 | 242.68 |

Table 2 compares the proposed iNTT design with the existing method. Referring to Table 2, the second row represents a Xilinx™ FPGA device. The existing method has been designed for a larger function such as polynomial multiplication. However, the existing method is adopted for this evaluation because the same circuit is reused for the iNTT and other functions. Referring to Table 2, in a case of Chen, only two BUs are arranged in the FPGA, and thus, the smallest amount of resources is used, and the second lowest throughput is achieved out of the four designs. In this regard, such a design may not be used in the RNS-based homomorphic encryption system. In a case of Roy, the lowest throughput is achieved as shown in the table, but the throughput may be further improved by arranging more core processors in the FPGA.

Further, it may be appreciated that the normalized throughput according to the present disclosure is two or three times greater than the throughputs of the existing methods. Such a result is obtained because the hardware design method according to the present disclosure uses a high degree of parallelism.

Referring to FPGA resource details of Table 2, it may be appreciated that, in the method according to an embodiment of the present disclosure, six GBUs excluding the BRAM occupy most of the resources. Specifically, the GBUs use 50% of the LUTs and 68% of the DSP slices. In a case of the BRAM, five RBs use 10 MB, which corresponds to the majority in the overall design. This size may be reduced by increasing the number of BUs using the DSP slices for which a tradeoff may be selected depending on available resources.

TABLE 3

| Parameter | w/o our method | w/ our method | Improvement |
|---|---|---|---|
| Set-A | 44.91 MB | 64.76KB | 99.86% |
| Set-B | 45.91 MB | 70.29KB | 99.85% |

Table 3 shows improvement in internal memory size in a case of calculating the prime number information every cycle without storing all of the prime number information. The first column shows the parameters used in the present disclosure, and the second and third columns show memory sizes for storing the square root information in the existing method and the proposed method, respectively. It may be appreciated that the memory size may be reduced by 99% in a case where the method according to the present disclosure is used as described above. As for the FPGA implementation, the iNTT software implementation and the FPGA implementation are compared to check a hardware acceleration effect.

TABLE 4

| | | |
|---|---|---|
| | Software lmpl. | FPGA impl. |
| Set-A | 387 ms | 3.28 ms |
| Set-B | 446 ms | 3.76 ms |

Table 4 shows execution times in a case where the algorithm is implemented in software and in a case where the FPGA is implemented according to the present disclosure. The second and third rows of Table 4 show results in a case of using the parameter sets A and B. It may be appreciated that the execution times for Set-A and Set-B in a case of the FPGA implementation when the frequency is 200 MHz are 3.23 ms and 3.76 ms, respectively, which are 115 times shorter than those in a case of the software implementation. Meanwhile, the ciphertext processing method according to various embodiments described above may be implemented in a form of a program code for performing each process, stored in a recording medium, and distributed. In this case, a device on which the recording medium is mounted may perform operations such as the encryption or ciphertext processing. The recording medium may be various types of computer-readable recording media such as a ROM, a RAM, a memory chip, a memory card, an external hard disk, a hard disk drive, a compact disc (CD), a digital versatile disc (DVD), a magnetic disk, and a magnetic tape.

Although the description of the present disclosure has been made with reference to the accompanying drawings, the scope of the rights of the present disclosure is defined by the appended claims and is not construed as being limited to the described embodiments and/or the drawings. In addition, it should be understood that various improvements, modifications and changes of the embodiments described in the claims which are obvious to those skilled in the art are included in the scope of rights of the present disclosure.

1. A calculation apparatus comprising:
a memory configured to store at least one instruction; and
a processor configured to execute the at least one instruction,
wherein the processor is configured to execute the at least one instruction to store predetermined base prime number information, generate first prime number information different from the base prime number information by reversing bits of the pre-stored base prime number information, and perform a modular calculation for the plurality of ciphertexts by using the generated first prime number information.

2. The ciphertext calculation apparatus as claimed in claim 1, wherein the base prime number information and the first prime number information are values obtained by addition and subtraction of three, four, or five exponentiations of 2 with different exponents.

3. The calculation apparatus as claimed in claim 1, wherein the processor includes:
an internal memory configured to store the base prime number information;
a GBU including a plurality of BUs including a plurality of calculators that perform different preset homomorphic calculations; and
a prime number generator configured to read the base prime number information from the internal memory, generate prime number information necessary for each of the plurality of BUs by reversing the bits of the base prime number information, and provide the generated prime number information to each of the plurality of BUs.

4. The calculation apparatus as claimed in claim 3, wherein the prime number generator generates the prime number information by converting a bit value of a k-th bit of the base prime number information into a log h-th bit integer.

5. The calculation apparatus as claimed in claim 3, wherein the prime number generator generates the first prime number information necessary for a first cycle by using the base prime number information, and generates second prime number information necessary for a second cycle by using the generated first prime number information and the base prime number information.

6. The calculation apparatus as claimed in claim 3, wherein the processor includes a plurality of GBUs,
the plurality of GBUs are arranged in series, and
the processor further includes a reordering buffer (RB) configured to store an output value of one of the GBUs and provide the stored output value to another GBU in an order different from a storing order.

7. The calculation apparatus as claimed in claim 3, wherein the GBU includes a plurality of stages, and
a plurality of BUs are arranged in parallel in each of the plurality of stages.

8. The calculation apparatus as claimed in claim 3, wherein at least two of the plurality of BUs in one GBU perform the homomorphic calculations by using the same prime number information.

9. The calculation apparatus as claimed in claim 3, wherein each BU includes:
a modulus subtractor configured to receive two homomorphic ciphertexts and output a value of a difference between the two homomorphic ciphertexts;
a modulus adder configured to receive two homomorphic ciphertexts and output an addition value of the two homomorphic ciphertexts; and
a modulus multiplier configured to perform modular multiplication by using the output value of the modulus subtractor and the prime number information.

10. The calculation apparatus as claimed in claim 9, wherein the modulus multiplier performs an individual shift calculation based on an exponent of each of a plurality of exponentiations of 2 constituting the prime number information, and performs modular multiplication by performing addition or subtraction of shift calculation results.

11. The calculation apparatus as claimed in claim 1, wherein the processor is a field programmable gate array (FPGA).

12. A ciphertext calculation method comprising:
receiving a modular calculation command for a plurality of ciphertexts;
performing a module calculation for the plurality of ciphertexts by using prime number information expressed by a combination of exponentiations of 2; and
outputting a result of the calculation,
wherein in the performing of the modular calculation, base prime number information is stored, bits of the base prime number information are reversed to generate first prime number information different from the base prime number information, and the modular calculation for the plurality of ciphertexts is performed by using the generated first prime number information.

13. The ciphertext calculation method as claimed in claim 12, wherein the base prime number information and the first prime number information are values obtained by addition and subtraction of three, four, or five exponentiations of 2 with different exponents.

14. The ciphertext calculation method as claimed in claim 12, wherein in the performing of the modular calculation, the first prime number information is generated by converting a bit value of a k-th bit of the base prime number information into a log h-th bit integer.

15. The ciphertext calculation method as claimed in claim 12, wherein in the performing of the modular calculation, the first prime number information necessary for a first cycle is generated by using the base prime number information, and second prime number information necessary for a second cycle is generated by using the generated first prime number information and the base prime number information.
